(19) United States
(12) Patent Application Publication
(10) Pub. No.: US 2025/0186180 A1
(43) Pub. Date: Jun. 12, 2025

(54) TOOTHBRUSH DATA AND STATUS DISPLAY

(71) Applicant: Ashtel Studios, Inc., Ontario, CA (US)

(72) Inventor: Anish Patel, Fontana, CA (US)

(73) Assignee: Ashtel Studios, Inc., Ontario, CA (US)

(21) Appl. No.: 18/535,951

(22) Filed: Dec. 11, 2023

(51) Int. Cl. A61C 17/22

(52) U.S. Cl. CPC A61C 17/222; A61C 17/221

(57) ABSTRACT

A toothbrush may remind a user when to replace his or her toothbrush. The toothbrush may include a display that displays the number of days left in the recommended life of the toothbrush. The display may also be used to remind the user of the remaining time period, provide messages to the user, provide advertisements and provide a link to a web-based location to purchase additional replacement brush heads.

### FIELD

The present invention generally pertains to toothbrushes and, more specifically, to a toothbrush configured to notify a user that he or she should replace the toothbrush after a predefined number of uses or a period of time.

### BACKGROUND

A consumer generally uses his or her toothbrush for approximately 8 months before replacing the toothbrush with a new toothbrush. Also, the average person brushes his or her teeth for 45 seconds to 75 seconds. Over time, this causes the bristles on the toothbrush to wear out and/or flare out. This also causes damage to a person's gums and enamel and ineffectively cleans teeth. For this reason, dentists recommend that users discard their toothbrushes, and replace them with a new toothbrush, after 90 days.

Furthermore, toothbrushes generally do not notify, or continuously notify, a user that he or she should replace the toothbrush after 90 days of use. Toothbrushes also fail to notify the user on a daily basis how many days are left in the recommended life of the toothbrush. Toothbrushes further fail to notify a user that he or she should replace their toothbrush when they are sick. Thus, an improved toothbrush may be beneficial.

### SUMMARY

Certain embodiments of the present invention may be implemented and provide solutions to the problems and needs in the art that have not yet been fully solved by conventional toothbrushes. For instance, some embodiments pertain to a toothbrush that reminds a user when to replace his or her toothbrush. The toothbrush may also include a timer to remind the user of the number of days left with respect to the recommended life of the toothbrush. The toothbrush may include daily dental tips for the benefit of the user.

In one embodiment, a toothbrush includes at least one processor and memory includes a set of instructions. The set of instructions and the at least one processor are configured to cause the toothbrush to determine an amount of time that has lapsed since initial activation of the toothbrush, and provide a user with a notification identifying a number of days that have lapsed since the initial activation of the toothbrush.

In another embodiment, a toothbrush includes at least one processor and memory including a set of instructions. The set of instructions and the at least one processor are configured to cause the toothbrush to determine a number of uses since initial activation of the toothbrush. The set of instructions and the at least one processor are also configured to cause the toothbrush to display a notification to a user identifying a number of uses remaining until replacement of the toothbrush should occur.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIGS. 1A-1H illustrate a timing toothbrush, according to an embodiment of the present invention.

FIG. 2 is a block diagram illustrating a computing system for a timing toothbrush, according to an embodiment of the present invention.

FIG. 3 is a flow diagram illustrating a process for activating an internal timer of a timing toothbrush, according to an embodiment of the present invention.

FIG. 4 is a flow diagram illustrating a process for incrementing a counter of a timing toothbrush, according to an embodiment of the present invention.

FIG. 5 is a flow diagram illustrating a process for activating an internal counter of a timing toothbrush, according to an embodiment of the present invention.

FIG. 6 is a flow diagram illustrating a process for incrementing a value of the internal counter of the timing toothbrush, according to an embodiment of the present invention.

FIG. 7A is a new brush head being detected by a toothbrush base using radio frequency identification (RFID) according to an embodiment of the present invention.

FIG. 7B is an interactive display notification of the toothbrush base according to an embodiment of the present invention.

FIG. 7C is an interactive display notification with a link to order new toothbrush heads according to an embodiment of the present invention.

FIG. 7D is a new brush head being detected by a toothbrush base using near field communication (NFC) according to an embodiment of the present invention.

FIG. 8 is a flow diagram illustrating a process for detecting and monitoring the lifecycle of a toothbrush head, according to an embodiment of the present invention.

FIG. 9 is a flow diagram illustrating a procedure conducted by the computer operating system of the brush base identifying a new toothbrush head should be ordered, according to an embodiment of the present invention.

FIG. 10 is a system diagram of a toothbrush initiating an order transaction to a remote site server for additional toothbrush heads, according to an embodiment of the present invention.

FIG. 11 illustrates example user interfaces for the toothbrush display according to an embodiment of the present invention.

FIG. 12 illustrates additional example user interfaces for the toothbrush displays according to an embodiment of the present invention.

FIG. 13 illustrates further additional example user interface toothbrush displays according to an embodiment of the present invention.

FIG. 14 illustrates yet further example user interface toothbrush displays according to an embodiment of the present invention.

### DETAILED DESCRIPTION OF THE EMBODIMENTS

Embodiments of the present invention pertain to a timing toothbrush. The timing toothbrush may provide a user with a notification that the timing toothbrush needs to be replaced after a predetermined number of days or uses. Each day, the timing toothbrush may also notify the user of the number of days remaining before the timing toothbrush should be replaced.

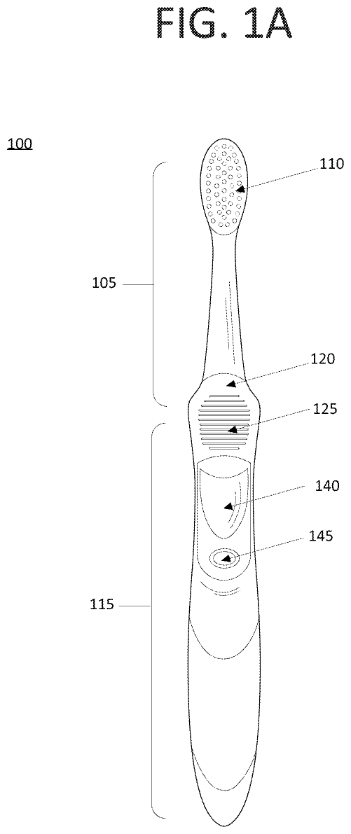

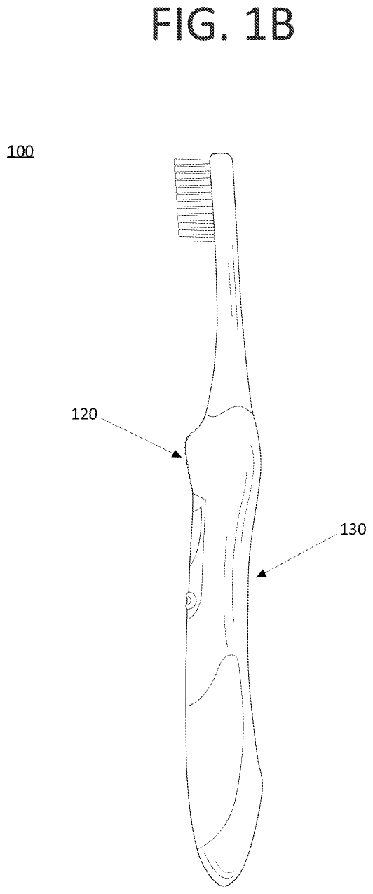

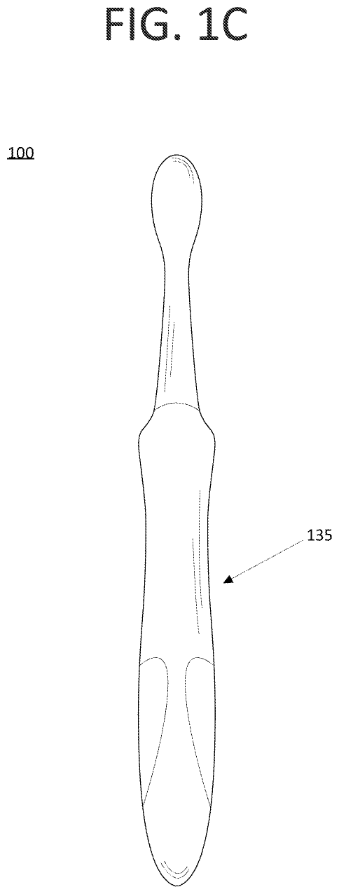

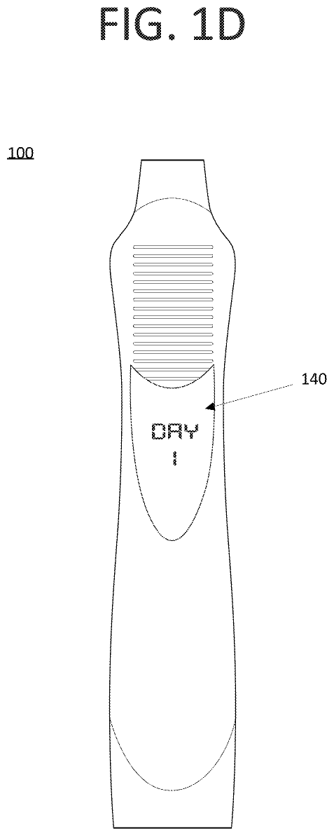

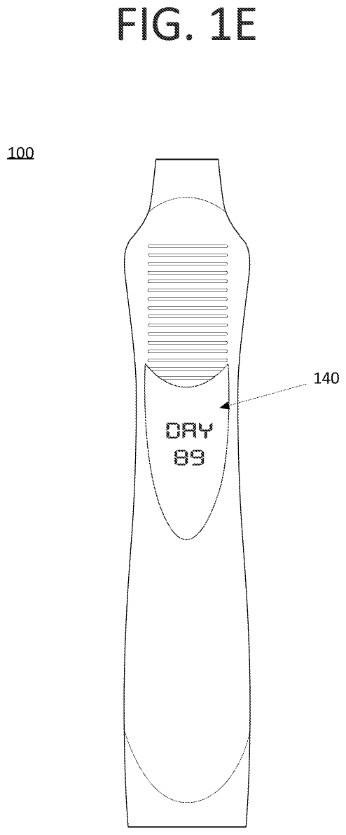

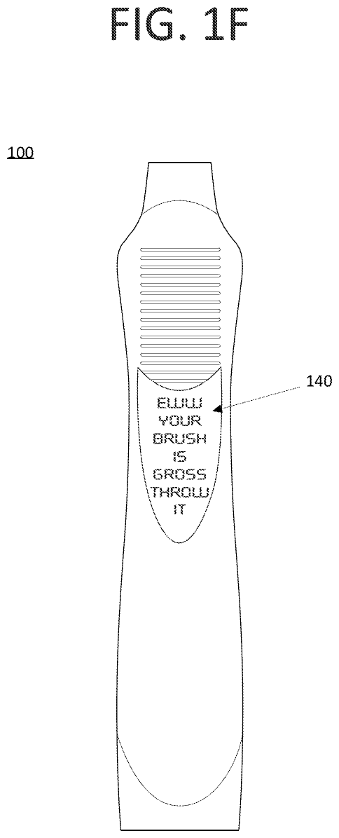

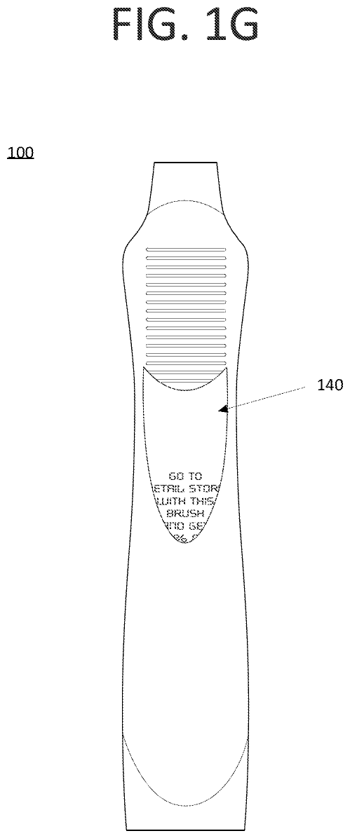

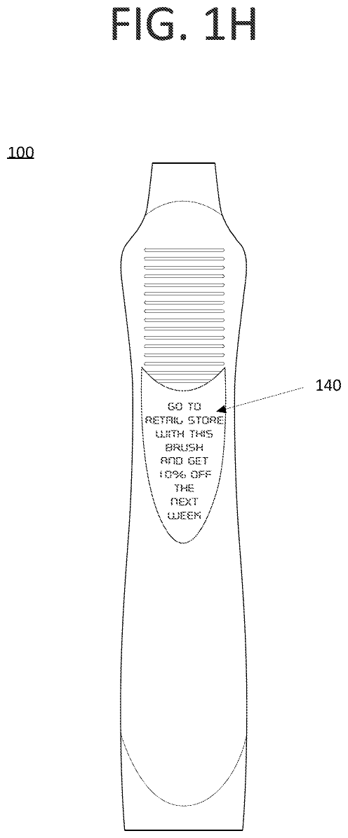

FIGS. 1A-1H illustrate a timing toothbrush 100, according to an embodiment of the present invention. Timing toothbrush 100 includes a head 105, which includes bristles 110. Timing toothbrush 100 also includes a body (i.e., a handle) 115 that allows a user to hold a timing toothbrush 100.

A material 120, such as rubber, surrounds a portion of body 115, allowing the user to firmly grip timing toothbrush 100. For ergonomic purposes, a thumb grip (or ergonomic grip) 125, along with indentation portions 130, 135, is provided. See, for example, FIGS. 1B and 1C.

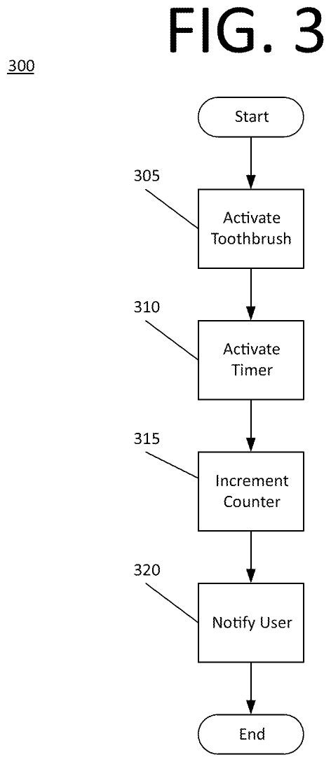

Timing toothbrush 100 also includes a display (e.g., liquid crystal display (LCD) screen) 140 to display information to the user and a button or switch 145 to activate and/or deactivate timing toothbrush 100. Although not shown in FIG. 1, timing toothbrush 100 includes a computing system. See, for example, computing system 300 of FIG. 3.

Timing toothbrush 100 also includes an audio and/or visual timer shown on display 140 providing one or more notifications to the user with respect to how much time is remaining for brushing his or her teeth. In some embodiments, the timer may be for the two minutes recommended by the American Dental Association (ADA), but any desired period of time may be used. Timing toothbrush 100 may also provide audio and/or visual instructions guiding the user as to where to brush his or her teeth.

FIGS. 1D-1H more clearly illustrate display 140 of timing toothbrush 100. In particular, FIGS. 1D-1H further illustrate the various messages displayed to the user. For example, during the predefined period of time (e.g. during the 90 days), display 140 provides educational messages to the user for better oral hygiene. After the predefined period of time (e.g., after 90 days), display 140 provides educational messages to the user as to why he or she needs to replace the toothbrush (or brush head) and how the toothbrush is harmful to the user.

Using an internal timer (not shown), display 140 shows the number of days timing toothbrush 100 has been in use. See, for example, FIGS. 1D and 1E. The internal timer may be activated upon the first use of a timing toothbrush 100. For example, on the first day of use, display 140 may display “Day 1”, on the second day of use, display 140 may display “Day 2”, and so on. This timer may progress up to, or beyond, the predefined period of time, e.g., 90 days.

In other embodiments, display 140 may show the number of days remaining before timing toothbrush 100 has to be replaced. For example, on the first day of use, display 140 may display 90 days, on the second day of use, display 140 may display 89 days, and so on. This way, the user knows how many days are remaining in the recommended life of timing toothbrush 100. In certain embodiments, display 140 may show the number of uses or the number of uses remaining before timing toothbrush 100 needs to be replaced.

During the predefined period of time, display 140 may also display messages, such as educational messages, inspirational messages, suggestions, etc., to the user. These messages may include, for example, “remember to brush your teeth for 2 minutes,” “brush at least twice a day,” “rinse your brush,” etc. This way, the user is encouraged to brush his or her teeth correctly.

When the number of days or uses is equal to or beyond the predefined period of time, display 140 may display a message, such as “Eww your brush is gross throw it”. See, for example, FIG. 1E. Other messages may include “You are hurting your teeth!”, “Change your brush immediately!”, etc. Each day that the user brushes his or her teeth beyond the predefined period of time, display 140 may display either the same message or a different message. This way, the user is encouraged to replace timing toothbrush 100 after the predefined period of time.

During the predefined period of time, or after the predefined period of time, display 140 may also display advertisements or promotions. For example, if the user purchased a timing toothbrush 100 from a retail store, display 140 may show an advertisement encouraging the user to purchase a new toothbrush for a discounted price from that retail store. See, for example, FIGS. 1F and 1G. This embodiments provides an incentive to the user to discard his current timing toothbrush 100 and replace it with a new timing toothbrush 100. It should be appreciated that the displayed messages and/or advertisements may be scrolled in a top to bottom, bottom to top, left to right, or right to left manner, or in any other desired manner. See, for example, FIGS. 1G and 1H.

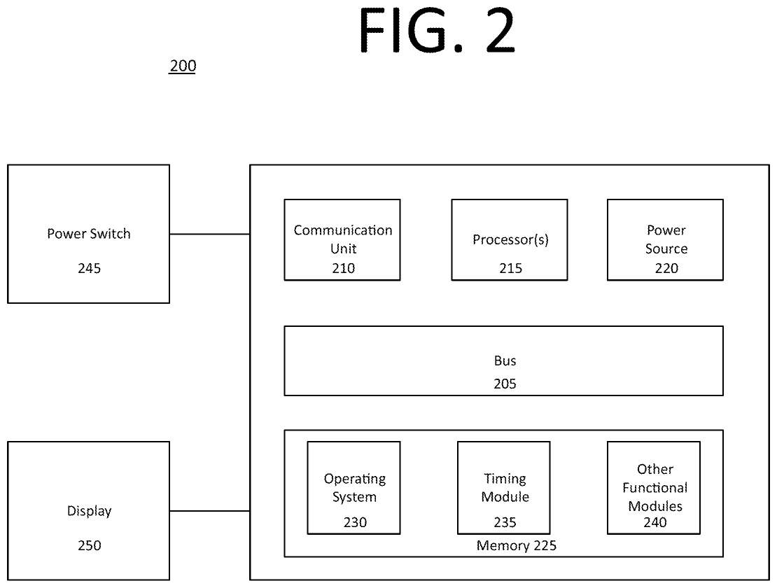

FIG. 2 is a block diagram illustrating a computing system 200 for a timing toothbrush, according to an embodiment of the present invention. Computing system 200 includes a bus 205 or other communication mechanism for communicating information, and processor(s) 215 coupled to bus 205 for processing information. Processor(s) 215 may be any type of general or specific purpose processor, including a central processing unit (“CPU”) or application specific integrated circuit (“ASIC”). Processor(s) 215 may also have multiple processing cores, and at least some of the cores may be configured to perform specific functions. However, in order to reduce cost, processor(s) 215 may be a small microcontroller in many embodiments.

Computing system 200 further includes memory 225 for storing information and instructions to be executed by processor(s) 215. Memory 225 may include any combination of random access memory (“RAM”), read only memory (“ROM”), flash memory, cache, static storage such as a magnetic or optical disk, or any other types of non-transitory computer-readable media or combinations thereof. Additionally, computing system 200 includes a communication device 210, such as a transceiver and antenna, to wirelessly provide access to a communications network.

Non-transitory computer-readable media may be any available media that can be accessed by processor(s) 210 and may include both volatile and non-volatile media, removable and non-removable media, and communication media. Communication media may include computer-readable instructions, data structures, program modules or other data in a modulated data signal such as a carrier wave or other transport mechanism and includes any information delivery media.

Memory 225 stores software modules that provide functionality when executed by processor(s) 215. The modules include an operating system 230 for computing system 200. The modules further include a timing module 235 that is configured to count the number of days the timing toothbrush has been in use, and also determine whether the timing toothbrush needs to be replaced. In some embodiments, each day is calculated based on a twenty-four hour period from the time the user activated his or her timing toothbrush for the first time.

In certain embodiments, timing module 235 may be configured to increment a counter based on the number of uses. Generally, a user should brush his or her teeth three times a day, and for each third use, the day may be incremented. However, some users may not brush their teeth three times a day. In this case, after 270 uses, for example, the user may be notified to change his or her timing toothbrush. This is also beneficial in the case where a user is on vacation and left his or her timing toothbrush at home. In this case, timing module 235 may not increment the counter while the user is not using his or her timing toothbrush.

Computing system 200 may also include one or more additional functional modules 235 that include additional functionality. For example, an advertisement module may cause display 250 to display advertisements encouraging the user to replace his or her timing toothbrush with a new timing toothbrush. A message module may cause display 250 to display encouragement messages or guidance messages during the life of the timing toothbrush, and provide additional messages after the life of the timing toothbrush to encourage the user to discard his or her current timing toothbrush.

Computing system 200 also includes a power source 220 configured to power the timing toothbrush when a power switch (or button) 245 is pressed. Power source 220 may include non-rechargeable or rechargeable batteries. Power switch 245 may activate and deactivate the timing toothbrush, including all of its electronics.

It should be noted that some of the system features described in this specification have been presented as modules, in order to more particularly emphasize their implementation independence. For example, a module may be implemented as a hardware circuit comprising custom very large scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, RAM, tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

FIG. 3 is a flow diagram 300 illustrating a process for activating an internal timer of a timing toothbrush, according to an embodiment of the present invention. The process shown in FIG. 3 may be executed by computing system 200 of FIG. 2, for example. In this embodiment, when a user activates, or turns on, his or her timing toothbrush for the first time at 305, an internal timer (or timing module) is activated at 310. This internal timer may count the number of days the timing toothbrush has been in use, the number of days remaining for the life of the timing toothbrush, the number of uses of the timing toothbrush, the number of uses remaining on the timing toothbrush, etc.

For simplicity, the following description relates to counting the number of days the timing toothbrush has been in use. The counter value for the internal timer is increased by one at 315, and is displayed to the user to illustrate the number of days the timing toothbrush has been in use. After the user has completed brushing his or her teeth, the timing toothbrush is deactivated, or turned off, at 320.

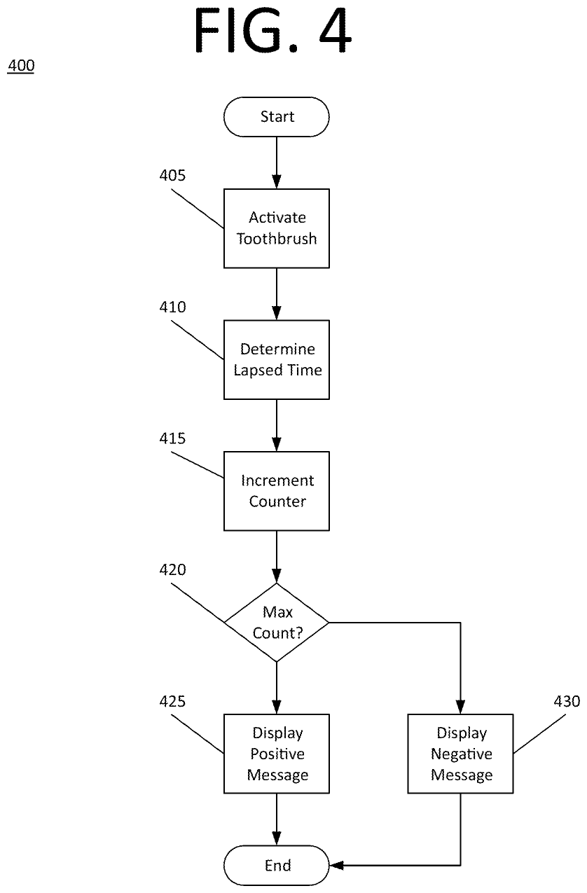

FIG. 4 is a flow diagram 400 for incrementing a counter of a timing toothbrush, according to an embodiment of the present invention. The process shown in FIG. 4 may be executed by computing system 200 of FIG. 2, for example. In this embodiment, each subsequent time the user activates his or her timing toothbrush at 405, the internal timer determines the amount of time that has lapsed since the first activation at 410. In another embodiment, the internal timer may determine the amount of time that has lapsed since the previous activation. In such an embodiment, every 24 hours that lapses may count as 1 day.

At 415, based on the determination at 410, the internal timer increments the counter value to show the number of days the timing toothbrush has been in use. For example, if 24 hours have lapsed, the counter value of the internal timer will have increased by 1, if 48 hours has lapsed, the counter value of the internal timer will have increased by 2, and so forth. This way, the internal timer may be able to determine whether the predetermined period of time, e.g., the life of the timing toothbrush, has elapsed.

At 420, the internal timer determines whether the counter value is greater or equal to the maximum counter value, i.e., the predetermined period of time. If the counter value is less than the maximum counter value, the internal timer causes a display to show the number of days the timing toothbrush has been in use at 425. The display may also show an encouragement (or positive) message and/or brushing instructions to the user of the timing toothbrush.

If, however, the counter value is greater than or equal to the maximum counter value, the internal timer causes the display to show the number of days the timing toothbrush has been used over the recommended period at 430. In some embodiments, the display may also show a discouragement (or a negative) message and/or instructions to the user of the timing toothbrush. The discouragement message may provide incentives to the user to replace the timing toothbrush. In certain embodiments, the display may also show advertisements for timing toothbrush replacement.

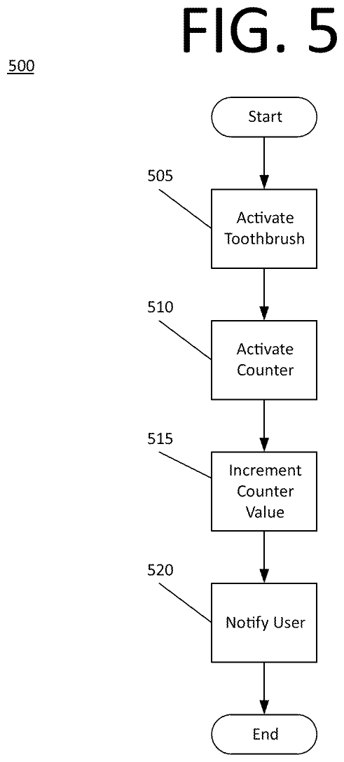

FIG. 5 is a flow diagram 500 illustrating a process for activating an internal counter of a timing toothbrush, according to an embodiment of the present invention. The process shown in FIG. 5 may be executed by computing system 200 of FIG. 2, for example. In this embodiment, when a user activates, or turns on, his or her timing toothbrush for the first time at 505, an internal counter (or timing module) is activated at 510. This internal counter may count the number of times the user has used his or her timing toothbrush.

A value for the internal counter is incremented by one at 515, and is displayed to the user to illustrate the number of times the timing toothbrush has been in use. After the user has completed brushing his or her teeth, the timing toothbrush is deactivated, or turned off, at 520.

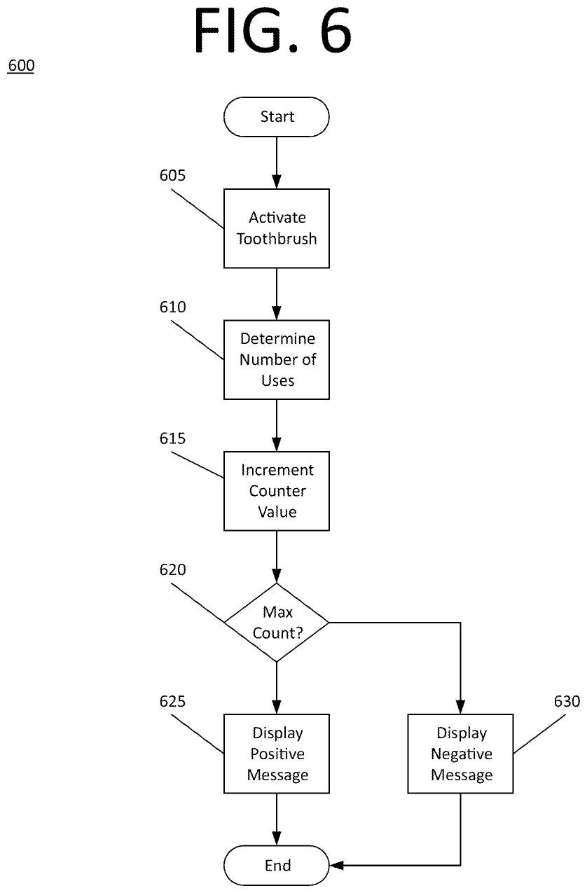

FIG. 6 is a flow diagram 600 for incrementing a value of the internal counter of the timing toothbrush, according to an embodiment of the present invention. The process shown in FIG. 6 may be executed by computing system 200 of FIG. 2, for example. In this embodiment, each subsequent time the user activates his or her timing toothbrush at 605, the internal counter determines the number of uses since the first activation of the timing toothbrush at 610. At 615, based on this determination, the value of the internal counter is incremented to show the number of times the user has used his or her timing toothbrush. For example, if the user used his or her toothbrush three times since activation of the timing toothbrush, the value of the internal counter will have increased by 3, if the user has used his or her toothbrush 4 times, the value of the internal counter will have increased by 4, and so forth. This way, the internal counter may be able to determine whether the maximum number of uses of the timing toothbrush has been exceeded.

At 620, the internal counter determines whether the counter value is greater or equal to the maximum counter value, e.g., the predetermined number of uses. If the value of the internal counter is less than the maximum counter value, the internal counter causes a display to show the number of uses of the timing toothbrush at 625. The display may also show an encouragement (or positive) message and/or brushing instructions to the user of the timing toothbrush.

If, however, the value of the internal counter is greater than or equal to the maximum counter value, the internal counter causes the display to show the number of uses beyond the recommended number of uses at 630. In some embodiments, the display may also show a discouragement (or a negative) message and/or instructions to the user of the timing toothbrush. The discouragement message may provide incentives to the user to replace the timing toothbrush. In certain embodiments, the display may also show advertisements for timing toothbrush replacement.

The process shown in FIGS. 3-6 may be performed, in part, by a computer program, encoding instructions for a nonlinear adaptive processor to cause at least the processes described in FIGS. 3-6 to be performed by the apparatuses discussed herein. The computer program may be embodied on a non-transitory computer readable medium. The computer readable medium may be, but is not limited to, a hard disk drive, a flash device, a random access memory, a tape, or any other such medium used to store data. The computer program may include encoded instructions for controlling the nonlinear adaptive processor to implement the process described in FIGS. 3-6, which may also be stored on the computer readable medium.

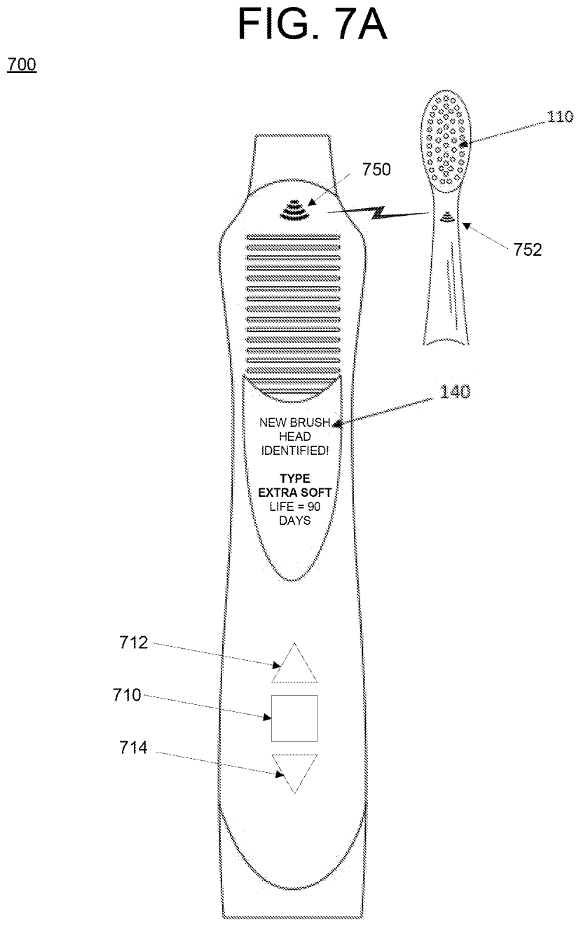

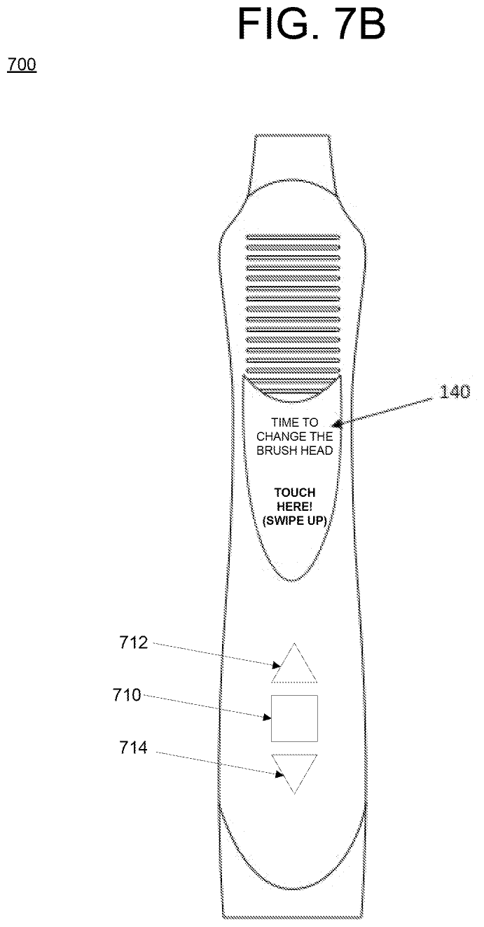

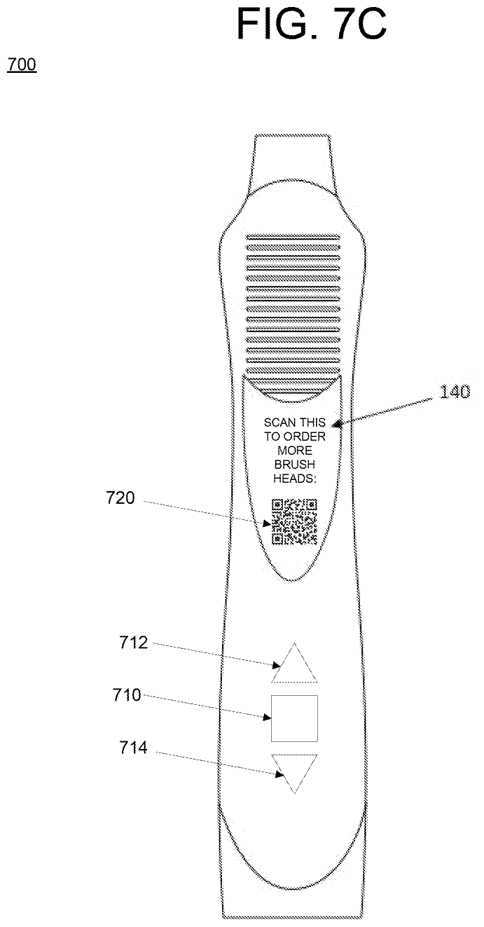

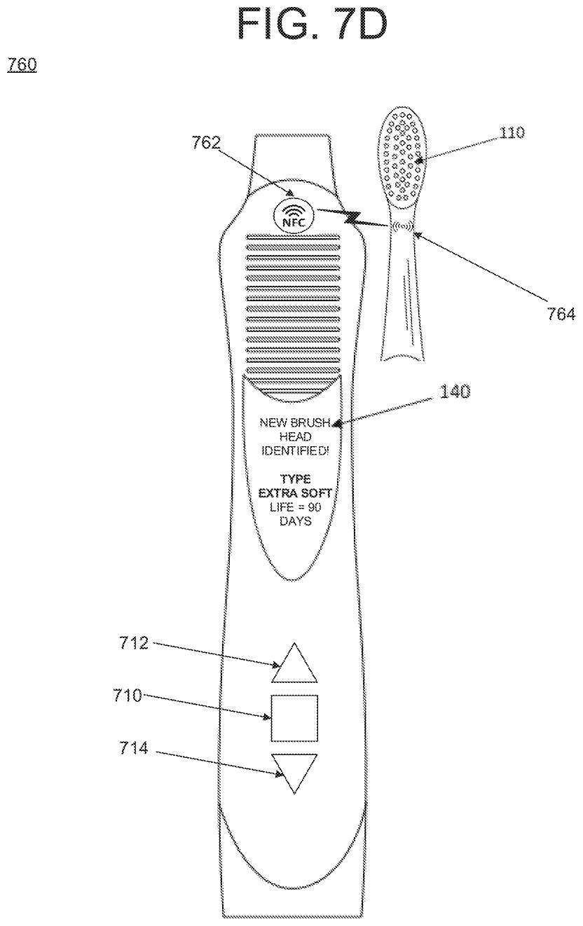

FIG. 7A is a new brush head being detected by a toothbrush base according to an embodiment of the present invention. Referring to FIG. 7A, the example 700 includes a brush base similar to the examples in FIGS. 1A-1H; however, in this example, the brush base may have a RFID reader 750 which can detect transmission signals of a RFID tag 752 (active or passive). The information shared between the brush head 110 and brush base may include a unique identifier of the brush head, a type of brush head (e.g., kids brush, soft brush, extra soft, medium brush, etc.). Also, or instead or the RFID tag, there may be a bit comparator or bit identifier inside the brush head and/or brush base which can digitally identify the type of brush, the type of presence of the brush etc., by an electrical current detected when a metal prong on the bottom of the brush head makes contact with a metal portion of the brush base.

The timer may begin to count the seconds/minutes/hours since the brush head was first placed on the brush base and notify a user when 90 days has matured. The brush may also have a series of buttons, such as on/off 710, intensity up 712 and intensity down 714. There may also be an LED (not shown) to demonstrate an intensity level currently being used by the brush system.

FIG. 7B is an interactive display notification of the toothbrush base according to an embodiment of the present invention. The example in FIG. 7B demonstrates how the toothbrush reminder may appear when the life cycle has matured. The display 140 may be a touch display that a user can touch to manipulate the screen text and present options and additional information, especially with regard to the brush changeout process.

FIG. 7C is an interactive display notification with a link to order new toothbrush heads according to an embodiment of the present invention. Referring to FIG. 7C, the example demonstrates how a QR code 720 may be presented to a user so a scan process by a phone or other device can offer a web link to a website for purchasing more brush heads. The QR code may be customized or may be one of many QR codes selected to be displayed based on a brush type initially detected. This may offer more specific purchase options for the user if one QR code is presented for a specific type of brush based on the type of brush head detected (e.g., extra soft bristles). The detected brush head type may be stored and used as the basis for selecting the QR code 720.

FIG. 7D is a new brush head being detected by a toothbrush base using near field communication (NFC) according to an embodiment of the present invention. Referring to FIG. 7D, the brush configuration 760 includes a near field communication (NFC) chip and/or configuration 762 that will need to come into very near proximity to the brush head (e.g., less than one or two inches) in order for the brush head to be recognized by its passive or active NFC transceiver 764. Once recognized by the brush base, the timer can be reset to initiate another lifecycle, such as 90 days prior to needing to replace the brush. Also, a QR code can be created customized to the exact type of brush head which will be displayed when the brush needs to be reordered on the display of the brush base configuration.

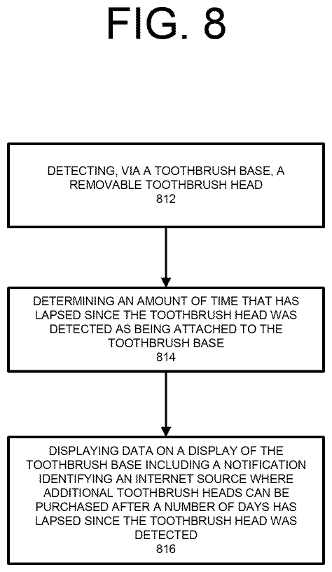

FIG. 8 is a flow diagram illustrating a process for detecting and monitoring the lifecycle of a toothbrush head, according to an embodiment of the present invention. Referring to FIG. 8, the example process may include detecting, via a toothbrush base, a removable toothbrush head 812, such as when a new one is inserted on the base for a first time, determining an amount of time that has lapsed since the toothbrush head was detected as being attached to the toothbrush base 814, and displaying data on a display of the toothbrush base such as a notification identifying an Internet source where additional toothbrush heads can be purchased after a number of days has lapsed since the toothbrush head was detected 816.

The process may also include receiving a selection on a touchscreen of the display, such as by a user finger or other input approach and responsive to receiving the touch selection, displaying a quick response (QR) code identifying the Internet source. Another example may include activating an internal timer upon the initial detection of the toothbrush head, incrementing a value of an internal timer based on the determined amount of time that has lapsed since an initial activation of the toothbrush head, determining whether the value of the internal timer is greater than or equal to a maximum value to determine whether a notification to replace is necessary. The process may also include displaying an advertisement for replacement of the toothbrush head with a same or similar toothbrush head when the value of the internal timer is greater than or equal to the maximum value. The toothbrush head may be identified via one or more of an electrical contact identifier of the toothbrush head and a radio signal received from a radio frequency identification (RFID) tag affixed to the toothbrush head. The process may also include identifying a type of toothbrush head based on the received radio signal or the detected electrical contact identifier, which may use a digital identity detection process based on a hardware circuit of the brush head. In another example, the communication between the brush head and base may be performed via electromagnetic data communications.

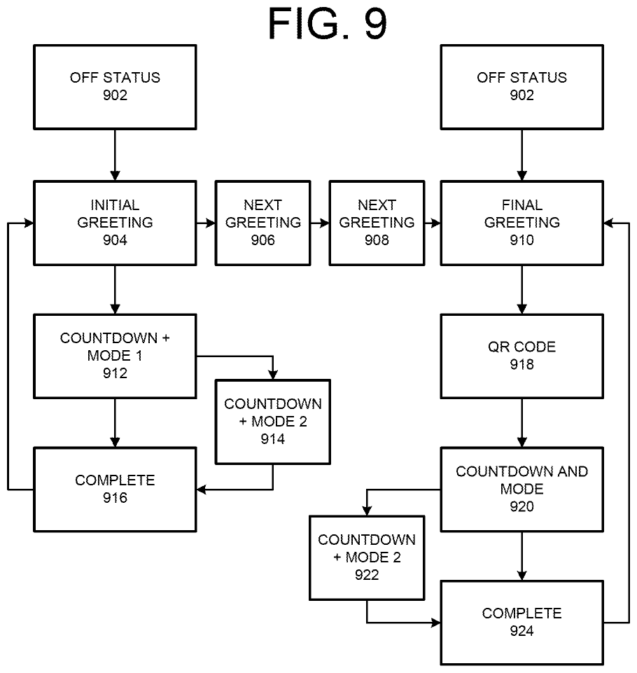

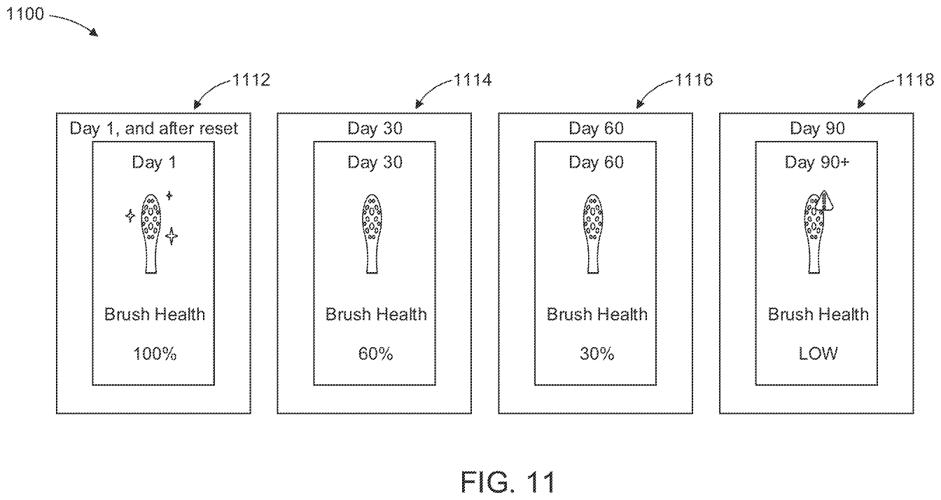

FIG. 9 is a flow diagram illustrating a procedure conducted by the computer operating system of the brush base identifying a new toothbrush head should be ordered. Referring to FIG. 9, the configuration may initiate with an off status of the brush 902 and then an initial greeting 904 when the brush is powered on by a power button. A first greeting data will be presented, notifying a user of 90 days of use left. The next greeting will be 24 hours later 906, such as when the user brushes their teeth and pushes the button the next day they may receive a notification that there are 89 days left. One day later will be the next greeting 908, such as you have 88 days left. After 90 days, the greeting will be a final greeting 910 that demonstrates the brush head must be replaced. FIG. 11 illustrates examples 1100 of day 1, day 30, day 60 and day 90 user interface displays 1112-1118, which provide reminders of the brush head health and current status.

The QR code may be created and displayed 918 based on the maturity data and the type of brush head needed, which is based on the previous brush head type used (e.g., extra soft, soft, medium, etc.). The brush type may be identified by a communication between the base and the brush head or via information stored in memory of the brush base. The different modes 920 and 922 may include different information being presented to the user such as information about why they should order the new brush head or reminders to perform the order. After a completed information session 924, the process will again repeat 910 to inform the user it is time to replace the head until the new head is inserted on the brush base and detected by communication signaling.

During the initial days of the brush use prior to the 90 day maturity point or the point of needing a new brush head, the countdown process 912 may include a message, such as instructions on how long to brush what portions of the user's teeth. Additional messages may be presented 914 depending on the last message presented to include further instructions. A cycle may complete 916 after a certain number of minutes or seconds. The process may be completed with the initial greeting 904 assuming the brush head does not need to be replaced.

During a regular cycle before the 90 day, or other time period, maturity point, the messages presented each day may be unique, such as a percentage of brush head life (e.g., 90%, 60%, etc.) remaining. After the maturity point, the messages may also be unique however the messages may be different reasons to replace the brush head, such as reasons to maintain good gum health, witty messages about why brushing with a new brush head is better than an old brush head, reminders on placing the order using the QR code, etc. A unique image may be displayed each time as well, such as a star for brushing correctly for the entire period of time, an image of water, floss, mouthwash and other items that are beneficial and/or candy, etc., which is not beneficial for one's teeth and an instruction to not eat too much candy or brush immediately after, etc.

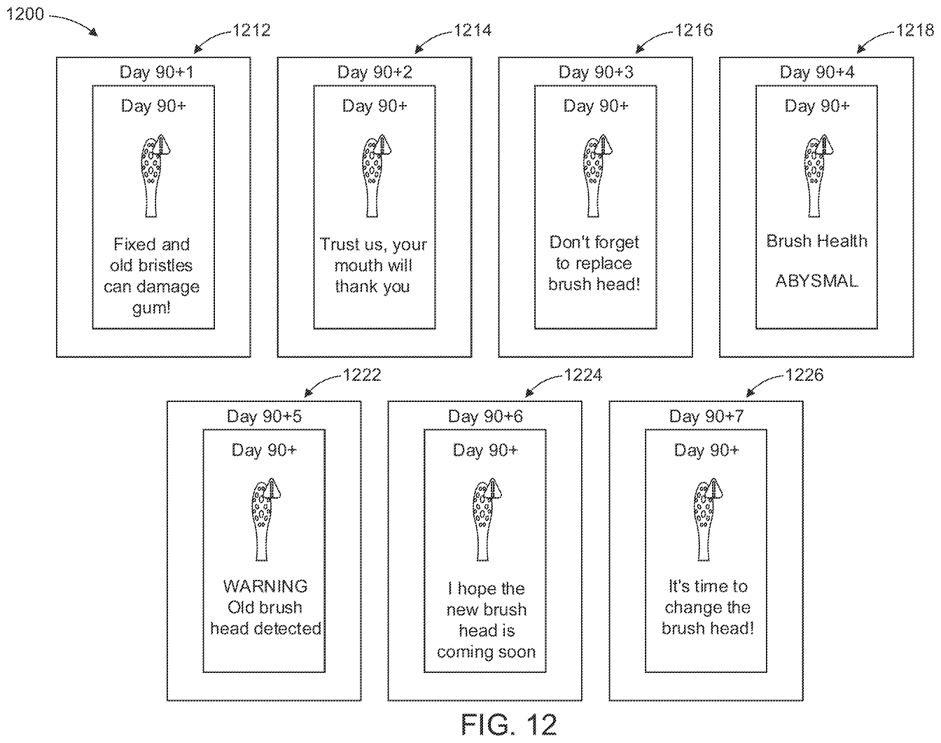

FIG. 12 illustrates examples 1200 of post 90 day user interface messages which provide unique messages each day to persuade a user to order a new brush head. The examples 1212-1226 demonstrate example messages which are unique each day after 90 days for a period of time, such as seven days past the 90 day maturity period of needing a new brush head.

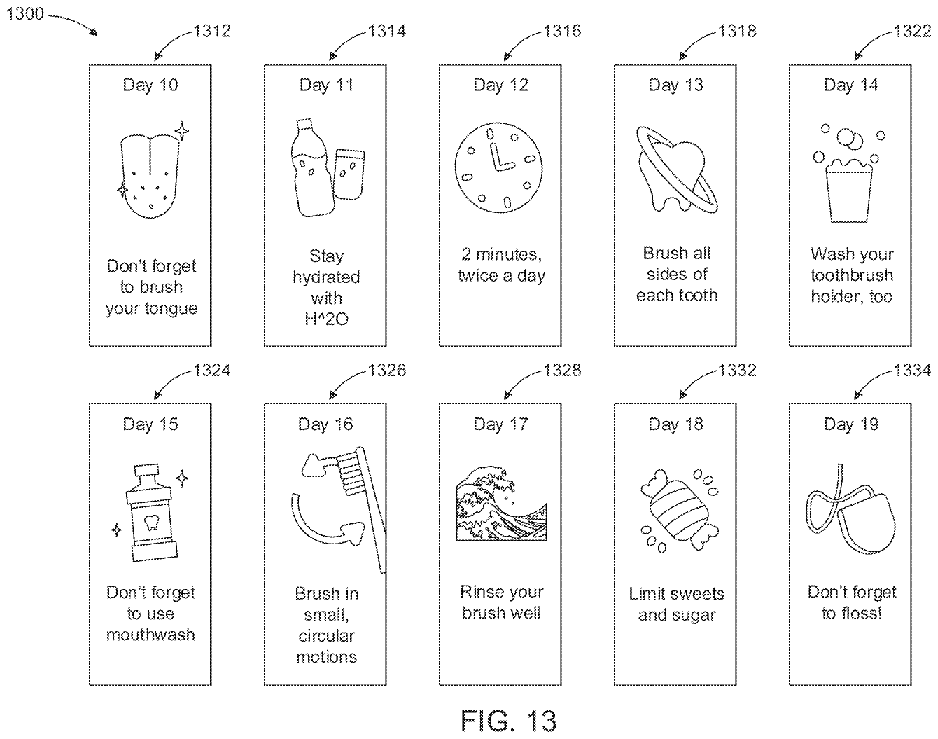

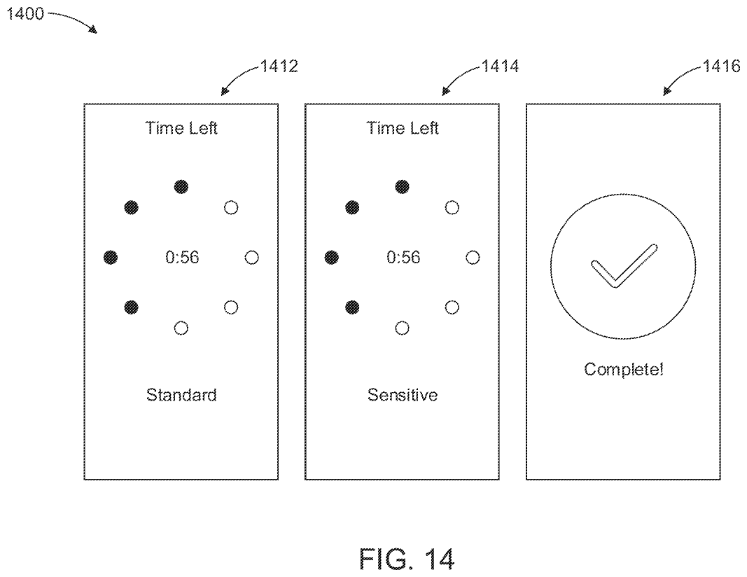

FIG. 13 illustrates examples 1300 of additional messages and reminders displayed on a user interface to provide unique tips and messages each day to persuade a user to brush properly. The examples 1312-1234 demonstrate example messages which are unique each day and promote optimal oral hygiene. Additionally, FIG. 14 illustrates an example 1400 of different status messages indicating the amount of time remaining until a brushing cycle is completed.

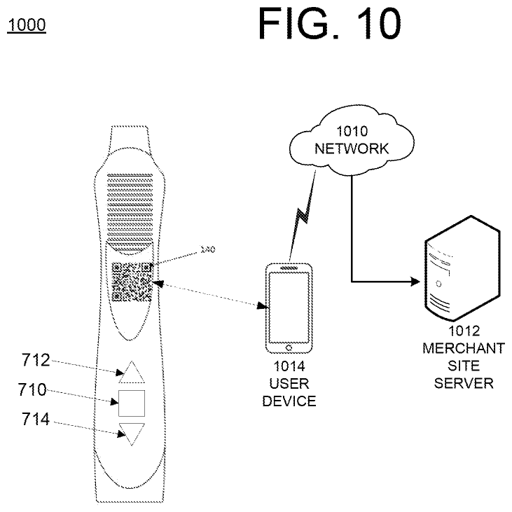

FIG. 10 is a system diagram of a toothbrush initiating an order transaction to a remote site server for additional toothbrush heads. Referring to FIG. 10, the system 100 includes the brush base 700 which may include a computer processor, memory, communication modules, etc. The brush base may automatically display the correct code on the maturity date or every day after that date so the user can use their device 1014 (e.g., smartphone, tablet, etc.) to scan the code via a camera scan function and initiate a link to the merchant site 1012 across a network 1010, such as a cellular network and/or Wi-Fi network. The link can then access a web based portal or site to identify the types of compatible brush heads that may be purchased and used with the brush base.

In one example, the system may include a toothbrush head and a toothbrush base configured to communicate with the toothbrush head to identify a type of toothbrush head associated with the toothbrush head by a processor and one or more communication mediums, display a quick response (QR) code on a maturity date associated with the toothbrush head, and the system may also include a computing device configured to scan the QR code on the display of the toothbrush base, such as a smartphone or other peripheral computing device and the system may also include a server configured to receive an order for additional toothbrush heads from the computing device.

The computer program can be implemented in hardware, software, or a hybrid implementation. The computer program can be composed of modules that are in operative communication with one another, and which are designed to pass information or instructions to display. The computer program can be configured to operate on a general purpose computer, or an application specific integrated circuit (“ASIC”).

In summary, a timing toothbrush may be configured to count the number of days the user has been using his or her timing toothbrush. When the counter is equal to, or is greater than, the maximum count, the timing toothbrush may be configured to notify the user that the timing toothbrush needs to be replaced, and also provides educational and/or encouragement messages.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A toothbrush, comprising:
a display;
at least one processor; and
memory comprising a set of instructions, wherein
the set of instructions and the at least one processor are configured to cause the toothbrush to
determine an amount of time that has lapsed since a removable toothbrush head was detected as being attached to a base of the toothbrush, and
display data on the display comprising a notification to a user identifying an Internet source where additional removable toothbrush heads can be purchased after a number of days that have lapsed since the toothbrush head was detected.

2. The toothbrush of claim 1, wherein the set of instructions and the at least one processor are further configured to cause the toothbrush to activate an internal timer upon the initial detection of the toothbrush head.

3. The toothbrush of claim 1, wherein the display data comprises a quick response (QR) code identifying an Internet uniform resource location (URL) address as the Internet source.

4. The toothbrush of claim 1, wherein the set of instructions and the at least one processor are further configured to cause the toothbrush to increment a value of an internal timer based on the determined amount of time that has lapsed since the initial activation of the toothbrush.

5. The toothbrush of claim 4, wherein the set of instructions and the at least one processor are further configured to cause the toothbrush to determine whether the value of the internal timer is greater than or equal to a maximum value.

6. The toothbrush of claim 5, wherein the set of instructions and the at least one processor are further configured to cause the toothbrush to display an encouragement message when the value of the internal timer is less than the maximum value.

7. The toothbrush of claim 5, wherein the set of instructions and the at least one processor are further configured to cause the toothbrush to display a toothbrush replacement message when the value of the internal timer is greater than or equal to the maximum value.

8. The toothbrush of claim 5, wherein the set of instructions and the at least one processor are further configured to cause the toothbrush to display an advertisement for replacement of the toothbrush with a same or similar toothbrush when the value of the internal timer is greater than or equal to the maximum value.

9. The toothbrush of claim 1, wherein the display is a touch screen display that provides data depending on selections made via user touch.

10. The toothbrush of claim 1, comprising
a plurality of buttons to perform one or more of turn on or off vibration or movement of the brush head, increase intensity of the vibration or movement and decrease intensity of the vibration or movement.

11. The toothbrush of claim 1, comprising
a radio frequency identification (RFID) reader configured to receive a radio signal from a passive or active RFID tag in the toothbrush head, wherein the radio signal comprises a type of toothbrush head.

12. The toothbrush of claim 11, wherein the notification comprises a QR code that identifies a web address link to the type of toothbrush head.

13. A method comprising:
detecting, via a toothbrush base, a removable toothbrush head;
determining an amount of time that has lapsed since the toothbrush head was detected as being attached to the toothbrush base; and
displaying data on a display of the toothbrush base comprising a notification identifying an Internet source where additional toothbrush heads can be purchased after a number of days has lapsed since the toothbrush head was detected.

14. The method of claim 13, comprising
receiving a selection on a touchscreen of the display; and
responsive to receiving the touch selection, displaying a quick response (QR) code identifying the Internet source.

15. The method of claim 13, comprising activating an internal timer upon the initial detection of the toothbrush head.

16. The method of claim 13, comprising incrementing a value of an internal timer based on the determined amount of time that has lapsed since an initial activation of the toothbrush head.

17. The method of claim 16, comprising determining whether the value of the internal timer is greater than or equal to a maximum value.

18. The method of claim 16, comprising displaying an advertisement for replacement of the toothbrush head with a same or similar toothbrush head when the value of the internal timer is greater than or equal to the maximum value.

19. The method of claim 13, wherein the toothbrush head is identified via one or more of an electrical contact identifier of the toothbrush head and a radio signal received from a radio frequency identification (RFID) tag affixed to the toothbrush head.

20. A system comprising
a toothbrush head;
a toothbrush base configured to
communicate with the toothbrush head to identify a type of toothbrush head associated with the toothbrush head;
display a quick response (QR) code on a maturity date associated with the toothbrush head;
a computing device configured to scan the QR code on the display of the toothbrush base; and
a server configured to receive an order for additional toothbrush heads from the computing device.
